(19) United States
(12) Patent Application Publication
(10) Pub. No.: US 2015/0046447 A1
(43) Pub. Date: Feb. 12, 2015

(54) MULTIMEDIA PLAYER DEVICE AND CONTROLLING METHOD THEREOF

(71) Applicant: Transcend Information, Inc., Taipei City (TW)

(72) Inventors: Chih-Chen HSUEH, Kaohsiung City (TW); Kuan-Jen CHEN, Yilan County (TW)

(73) Assignee: Transcend Information, Inc., Taipei City (TW)

(21) Appl. No.: 13/959,756

(22) Filed: Aug. 6, 2013

(51) Int. Cl. G06F 17/30

(52) U.S. Cl. CPC G06F 17/30053; G06F 17/3074; G06F 17/30244; G06F 17/30781
USPC 707/736

(57) ABSTRACT

A controlling method of a multimedia player device is disclosed. The multimedia player device is capable of playing plural multimedia files from plural memory cards. The controlling method comprising: when a memory card of the memory cards is connected to the multimedia player device, determining if there is a corresponding log file corresponding to the connected memory card; if the log file exists, creating a playlist comprising at least part of the plural multimedia files according to the log file; and, playing the multimedia files according to the playlist from the connected memory card.

### BACKGROUND

1. Field of Invention

The present application relates to a multimedia player device. More particularly, the present application relates to a controlling method of the multimedia player device capable of loading multimedia files from a memory card.

2. Description of Related Art

A multimedia player is popular in many applications, because it has functions such as playing audio files, playing video files, displaying digital photo files, etc. In order to extend storage space on the multimedia player, the multimedia player usually equips with a connection slot for interconnecting with an external storage unit, e.g., a memory card. The memory card is not a fixed component of the multimedia player. Users may keep their multimedia files into several different memory cards. When a user want to play other files stored in another memory card, the user may unplug the current memory card and insert the target memory card into the multimedia player.

There may be many multimedia files stored in each of memory cards. When a user inserts a memory card into the multimedia player, the user is required to assign which multimedia files in the inserted memory card should be played now. The user may not remember which file of the multimedia files has been played in the last time. In some cases, the user may always play specific files (e.g., some files at high priority in alphabetical order) when some other files have not been played even once. Therefore, a controlling method is required to manage the multimedia player while playing multimedia files from external sources.

### SUMMARY

An aspect of the present disclosure is to provide a controlling method of a multimedia player device. The multimedia player device is capable of playing plural multimedia files from plural memory cards. The controlling method comprising: when a memory card of the memory cards is connected to the multimedia player device, determining if there is a corresponding log file corresponding to the connected memory card; if the log file exists, creating a playlist comprising at least part of the plural multimedia files according to the log file; and, playing the multimedia files according to the playlist from the connected memory card.

Another aspect of the present disclosure is to provide a multimedia player device comprising a connection interface, a database and a processing unit. The connection interface is configured for electrically connected with different memory cards. The database is configured for storing log files respectively corresponding to the memory cards which have been connected with the connection interface. The processing unit is electrically connected with the connection interface and the database. When one of the memory cards is connected to the connection interface and the log file corresponding to the connected memory card exists, the processing unit creating a playlist according to the existed log file to play the multimedia files from the connected memory card.

### BRIEF DESCRIPTION OF THE DRAWINGS

The disclosure can be more fully understood by reading the following detailed description of the embodiments, with reference made to the accompanying drawings as follows:

FIG. 1 is flow charts illustrating a controlling method of a multimedia player device according to an embodiment of the disclosure;

FIG. 2 is a functional block diagram illustrating the multimedia player device 200 and corresponding memory cards 310˜340 according to an embodiment of the disclosure;

FIG. 3 is a schematic diagram illustrating multimedia files 312˜342 in the memory cards 310˜340 according to an embodiment of the disclosure; and

FIG. 4 is a flow chart illustrating further steps of the controlling method shown in FIG. 1.

### DETAILED DESCRIPTION

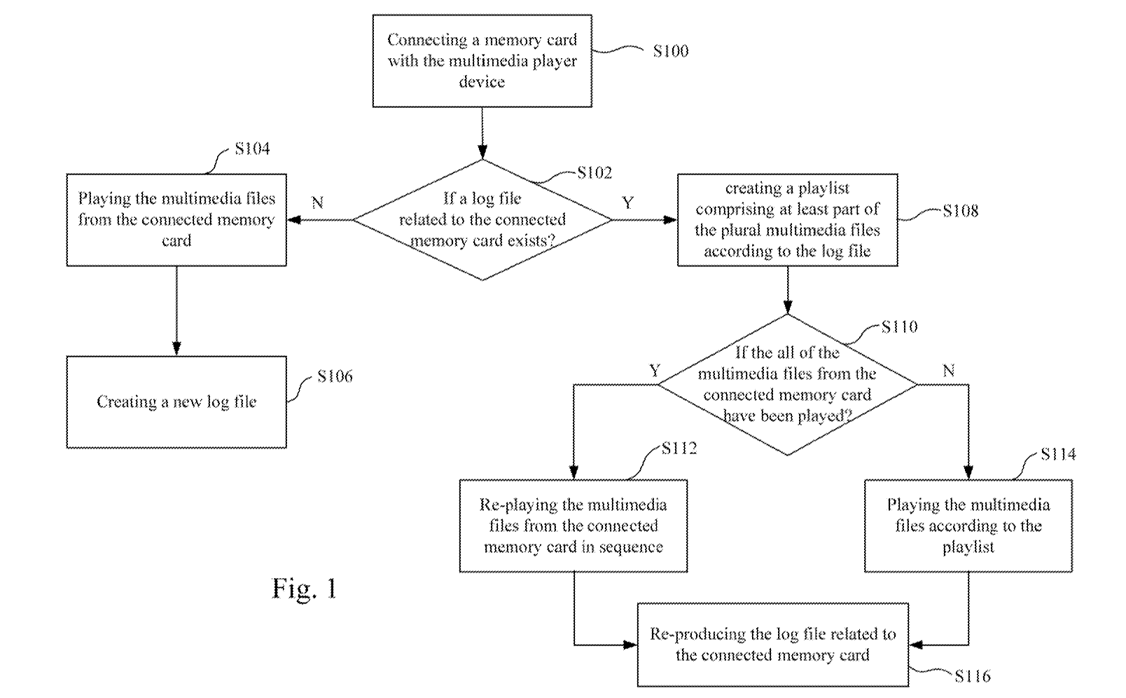

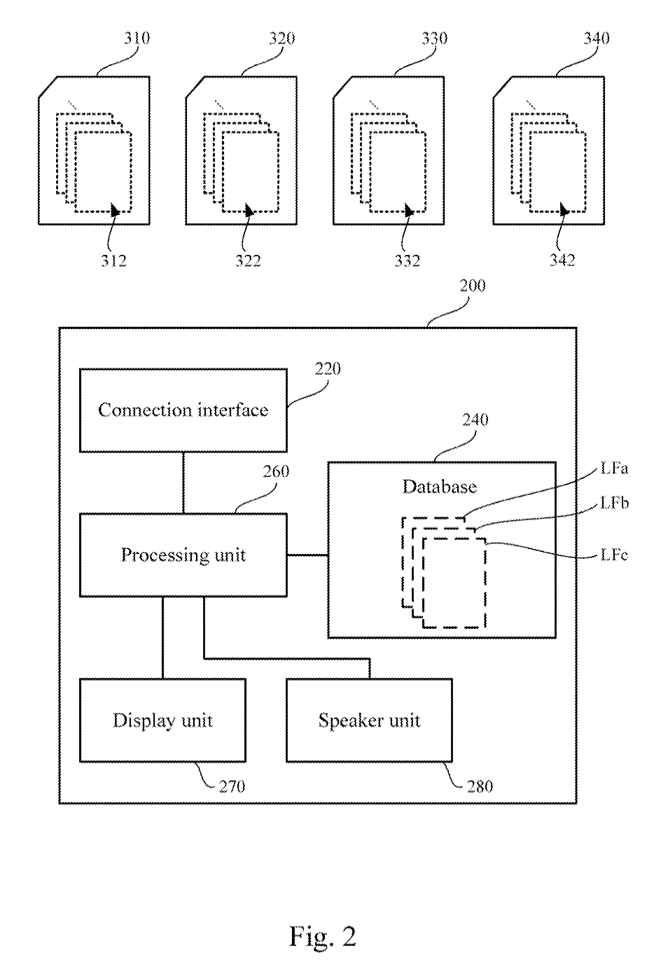

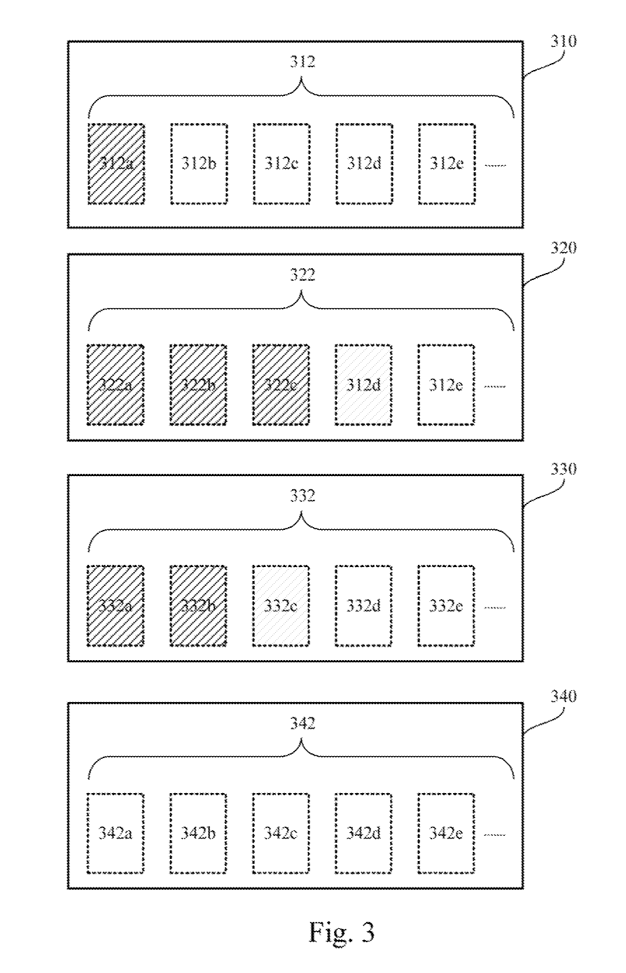

Reference is made to FIG. 1, FIG. 2 and FIG. 3. FIG. 1 is flow charts illustrating a controlling method of a multimedia player device. In the embodiment, the multimedia player device is capable of playing plural multimedia files from plural memory cards. FIG. 2 is a functional block diagram illustrating the multimedia player device 200 and corresponding memory cards 310˜340 according to an embodiment of the disclosure. FIG. 3 is a schematic diagram illustrating multimedia files 312˜342 in the memory cards 310˜340 according to an embodiment of the disclosure. In FIG. 2 and FIG. 3, four memory cards 310˜340 and multimedia files thereof are shown for demonstration. However, the multimedia player device 200 is not limited to work with a specific amount of memory cards shown in FIG. 2, and the multimedia files 312˜342 in the memory cards 310˜340 are not limited to a specific amount shown in FIG. 3.

In the embodiment of FIG. 2, four memory cards 310, 320, 330 and 340 are illustrated. Each of the memory cards 310˜340 includes some multimedia files 312˜342. The multimedia player device 200 may include a connection interface 220, a database 240, a processing unit 260, a display unit 270 and a speaker unit 280. The connection interface 220 is configured for electrically connected with the memory cards 310˜340. In this embodiment, the memory cards 310, 320 and 330 has been connected to the multimedia player device 200. Therefore, there are three log files LFa, LFb and LFc, which are corresponding to the memory cards 310, 320 and 330 respectively, existed already in the database 240 of the multimedia player device 200. In addition, different log files LFa, LFb and LFc are maintained by the multimedia player device corresponding to each played multimedia file from different memory cards 310, 320 and 330.

As shown in FIG. 1 and FIG. 2, the controlling method executes step S100 for connecting a memory card (e.g., any one of the memory cards 310, 320, 330 or 340) with the connection interface 220 of the multimedia player device 200.

Afterward, step S102 is executed for determining if a log file corresponding to the connected memory card exists in the database 240 of the multimedia player device 200. For example, if the memory card 340 is connected with the multimedia player device 200, no log file corresponding to the connected memory card 340 exists in the multimedia player device 200, and then the controlling method perform steps S104 to S106.

Step S104 is executed for playing the multimedia files 342 from the connected memory card. Based on a media type (e.g., an audio file, a video file or a photo file) of the multimedia files 342, the processing unit 260 plays the multimedia files 342 on the display unit 270 and/or through the speaker unit 280. Afterward, step S106 is executed for creating a new log file by the processing unit 260 for recording which multimedia files 342 from the connected memory card 340 has been played so far (i.e., establishing a list of the played multimedia files) on the multimedia player device 200. Therefore, the log file could be treated as a playing history record of the multimedia files 342.

On the other hand, if it is the memory card 310, 320 or 330 being connected with the multimedia player device 200, the log file LFa, LFb or LFc corresponding to the connected memory card 310, 320 or 330 does exist in the multimedia player device 200, and then the controlling method perform steps S108 to S116, so as to play the multimedia files from the connected memory card 310, 320 or 330 according to the existed log file LFa, LFb or LFc respectively.

Step S108 is executed for loading the existed log file LFa, LFb or LFc (corresponding to the connected memory card 310, 320 or 330) and creating a playlist comprising at least part of the plural multimedia files according to the log file. In this embodiment, the processing unit 260 creates the playlist according to the existed log file for playing the multimedia files from the connected memory card 310, 320 or 330. The playlist is created by excluding any multimedia file from the connected memory card and has been played on the multimedia player device. In other words, the playlist include the multimedia files have not been played on the multimedia player device.

FIG. 3 is used for demonstrating an example diagram about the information contained in the log files LFa, LFb and LFc. In this example, each of the memory cards 310, 320, 330 and 340 include multimedia files 312a˜312e, 322a˜322e, 332a˜332e and 342a˜342e respectively. It is assumed that, the multimedia file 312a, 322a, 322b, 322c, 332a and 332b has been played on the multimedia player device 200 already.

Each log file (e.g., the existed log file LFa, LFb, LFc or aforesaid new log file) corresponding to each memory card records an identification (ID) of the multimedia player device, an ID of the memory card, file names of the multimedia files (from the memory card and has been played on the multimedia player device) and/or additional information of the multimedia files has been played. The additional information can be information of a played file size, a total file size and/or a played count.

In an embodiment, the log file LFa includes the ID of the memory card 310, the file name of the multimedia file 312a and the additional information of the multimedia file 312a; the log file LFb includes the ID of the memory card 320, the file names of the multimedia files 322a, 322b and 322c and the additional information of the multimedia files 322a, 322b and 322c; and, the log file LFc includes the ID of the memory card 330, the file names of the multimedia files 332a and 322b and the additional information of the multimedia files 332a and 332b.

In another embodiment, each log file may be record in a format of [SYSTEMa—FILE—FILE_info] in which SYSTEMa is an ID of the multimedia player device 200, FILE is the file name/file ID of the played multimedia file, and the FILE_info can be a file size of the played multimedia file. For example, the log files existed on the multimedia layer device 200 can includes:
[SYSTEMa—FILE 312a—90 KB]:
[SYSTEMa—FILE 322a—180 KB]:
[SYSTEMa—FILE 322b—72 KB];
[SYSTEMa—FILE 322c—1080 KB];
[SYSTEMa—FILE 332a—990 KB];
[SYSTEMa—FILE 332b—5 KB].

Step S110 is executed for determining if all of the multimedia files from the connected memory card 310, 320 or 330 have been played.

If there is a multimedia file which has not been played yet, step S114 is executed for playing such the multimedia files according to the playlist. In an example, if the memory card 310 is connected to the multimedia player device 200, step S114 is achieved by excluding the multimedia file 312a has been played on the multimedia player device 200, and playing the multimedia files 312b, 312c, 312d or 312e have not been played. In another example, if the memory card 320 is connected to the multimedia player device 200, step S114 is achieved by excluding the multimedia file 322a, 322b and 322c has been played on the multimedia player device 200, and playing the multimedia files 322d or 322e have not been played. In another example, if the memory card 330 is connected to the multimedia player device 200, step S114 is achieved by excluding the multimedia file 332a and 332b has been played on the multimedia player device, and playing the multimedia files 332c, 332d or 332e have not been played.

On the other hand, if all multimedia file on the connected memory card has been played already, step S112 is performed for replaying the multimedia files from the connected memory card in sequence. Step S112 can be achieved by re-playing the multimedia files from the connected memory card in sequence started from the earliest played multimedia file, or by re-playing the multimedia files from the connected memory card in sequence started from a multimedia file with the lowest played count according to the corresponding log file.

After step S112 or S114, step S116 is performed for re-producing the log file corresponding to the connected memory card. For example, the file name and additional information (e.g., the played count, the played file size, etc) of the multimedia files has been played are required to be revised after step S112 or S114.

Furthermore, according to a file type of the multimedia files, the played count can be generated in different ways in this disclosure. Firstly, when the multimedia files are audio files, the played count of each audio file is accumulated after the audio file is completely played. Secondly, when the multimedia files are photo files, the played count of each photo file is accumulated after the photo file is displayed. Thirdly, when the multimedia files are video files and the video file is not completely played, the terminated position, or the played file size of each video file can be recorded in this case; and, the played count of each video file will be accumulated after the video file is completely played.

In aforesaid embodiments, the log files are stored in the database 240 in the multimedia player device 200. However, this disclosure is not limited to this way. In another embodiment, the log files can be stored in each memory card 310˜340 and loaded by the processing unit 260 via the connection interface 220.

For example, when the log files are stored in each memory card 310˜340, the log files can be configured for recording information about that each multimedia file on the memory card (310, 320, 330 or 340) has been played on different multimedia player devices. In this case, when there is a multimedia player device is connected with the memory card 310, 320, 330 or 340, the multimedia player device can generate a playlist according to the log files in the memory card 310, 320, 330 or 340, and the log files shows which multimedia files has been played on the multimedia player device before.

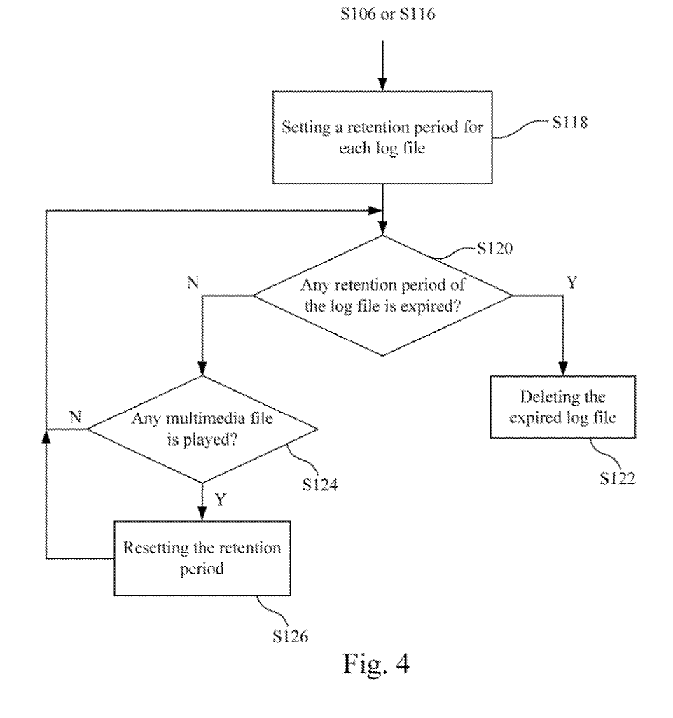

Reference is made to FIG. 1 and FIG. 4. FIG. 4 is a flow chart illustrating further steps of the controlling method shown in FIG. 1. As shown in FIG. 4, after step S106 (i.e., creating a new log file) or S116 (i.e., re-producing the log file), step S118 is performed for setting a retention period for each log file. The retention period can be a time period and preset or predetermined by the user of the multimedia player device 200. For example, the preset or predetermined retention period can be six months (or any predetermined time period). Step S120 is performed for detecting the retention periods of all existed log files to find out if any retention period is expired. Step S122 is performed for deleting an expired log file (i.e., the retention period of the log file is expired). In this way, the log files (stored in the database or each memory card) can be re-organized periodically, and the database or the memory card may get rid of redundant/old log files.

On the other hand, if step S124 detects that a multimedia file is played again on the multimedia player device, step S126 is performed for resetting the retention period of the multimedia file which is just played.

In practices, step S120 and the following steps (e.g., steps S122, S124, S126, etc) is not limited to be executed after step S118. In another embodiment, step S120 and the following steps can be executed periodically and automatically by the multimedia player device 200.

Based on aforesaid embodiments, this disclosure provides the controlling method for the multimedia player device, such that the multimedia player device can easily recognize the newly-inserted memory card and play the multimedia files have been played before (or with the fewest played count). Even when the memory card is temporarily removed from the multimedia player device, the log file corresponding to the memory card can keep the records till the next connection.

It will be apparent to those skilled in the art that various modifications and variations can be made to the structure of the present application without departing from the scope or spirit of the application. In view of the foregoing, it is intended that the present application cover modifications and variations of this application provided they fall within the scope of the following claims.

What is claimed is:

1. A controlling method of a multimedia player device, the multimedia player device being capable of playing plural multimedia files from plural memory cards, the controlling method comprising:
when one of the plural memory cards is connected to the multimedia player device, determining if there is a log file corresponding to the connected memory card;
if the log file exists, creating a playlist comprising at least part of the plural multimedia files according to the log file; and
playing the multimedia files according to the playlist from the connected memory card.

2. The controlling method of claim 1, further comprising:
if there is no log file corresponding to the connected memory card, playing the multimedia files from the connected memory card on the multimedia player device and creating a new log file for recording a history of the played multimedia file.

3. The controlling method of claim 1, wherein the log file corresponding to the memory card records an identification of the multimedia player device, an identification of the memory card, file names of the multimedia files which have been played on the multimedia player device, and additional information of the played multimedia files.

4. The controlling method of claim 3, wherein the additional information of the played multimedia files comprises information selected from the group consisted of a played file size, a total file size and a play count.

5. The controlling method of claim 4, wherein, when the multimedia files are audio files, the controlling method further comprises:
refreshing the play count of each audio file after the audio file is completely played.

6. The controlling method of claim 4, wherein, when the multimedia files are photo files, the controlling method further comprises:
refreshing the play count of each photo file after the photo file is displayed.

7. The controlling method of claim 4, wherein, when the multimedia files are video files, the controlling method further comprises:
recording the terminated position of the video file when the video file is not completely played; and
refreshing the played count of each video file after the video file is completely played.

8. The controlling method of claim 1, wherein the log file corresponding to the memory card is stored in the multimedia player device.

9. The controlling method of claim 1, wherein the log file corresponding to each of the plural memory cards is stored separately in each memory card.

10. The controlling method of claim 1, wherein, if the log file corresponding to the connected memory card exists, the controlling method further comprises:
creating the playlist to exclude any multimedia file which has been played on the multimedia player
playing the multimedia files according to the playlist and
re-producing the log file corresponding to the connected memory card.

11. The controlling method of claim 10, wherein, if all of the multimedia files from the connected memory card have been played, the controlling method further comprises:
re-playing the multimedia files from the connected memory card in sequence started from the earliest played multimedia file.

12. The controlling method of claim 10, wherein, if all of the multimedia files from the connected memory card have been played, the controlling method further comprises:
re-playing the multimedia files from the connected memory card in sequence started from a multimedia file with the lowest played count.

13. The controlling method of claim 1, wherein different log files are maintained by the multimedia player device corresponding to each played multimedia file from different memory cards.

14. A multimedia player device, comprising:
a connection interface configured for electrically connected with a memory card;
a database configured for storing a log file corresponding to the memory card which has been connected with the connection interface; and
a processing unit electrically connected with the connection interface and the database, and when the memory card is connected with the connection interface, the processing unit creating a playlist according to the log file to play multimedia files from the connected memory card.

15. The multimedia player device of claim 14, wherein the processing unit plays the multimedia files from the connected memory card and creates a new log file for recording a history of the played multimedia file from the connected memory card on the multimedia player device when the memory card is connected with the connection interface and there is no log file corresponding to the connected memory card.

16. The multimedia player device of claim 14, wherein the log file corresponding to the memory card records an identification of the multimedia player device, an identification of the memory card, file names of the multimedia files which have been played on the multimedia player device, and additional information of the played multimedia files.

17. The multimedia player device of claim 16, wherein the additional information of the played multimedia files comprises information selected from the group consisted of a played file size, a total file size and a played count.

18. The multimedia player device of claim 16, further comprising a display unit and a speaker unit electrically connected with the processing unit, wherein the processing unit plays the multimedia files on the display unit and/or through the speaker unit.
